(19) United States
(12) Patent Application Publication
(10) Pub. No.: US 2009/0314355 A1
(43) Pub. Date: Dec. 24, 2009

(54) SQUIB VALVE ASSEMBLY

(75) Inventor: Andrew L. Szeglin, Hauppauge, NY (US)

Correspondence Address: HOFFMANN & BARON, LLP, 6900 JERICHO TURNPIKE, SYOSSET, NY, 11791, US

(73) Assignee: Target Rock Division of Curtiss-Wright Flow Control Corporation, E. Farmingdale, NY (US)

(21) Appl. No.: 12/109,746

(22) Filed: Apr. 25, 2008

(51) Int. Cl. F16K 17/40

(52) U.S. Cl. 137/68.13; 137/68.14; 137/797

(57) ABSTRACT

The present invention includes a valve assembly having a fluid flow passage, a piston passage, a closure element and a moveable piston. The fluid flow passage extends from an inlet port to an outlet port. The piston passage transects and is oriented non-parallel to the fluid flow passage. The closure element interrupts fluid communication between the inlet and outlet ports. The piston being moveable within the piston passage between a first and second position, the piston including a head for opening the closure element wherein movement of the piston between the first and second positions enables fluid communication between the inlet and outlet ports. The valve assembly can include an explosive actuation mechanism for rapid actuation of the piston from the first position to the second position.

### BACKGROUND OF THE INVENTION

The invention relates to an explosively actuated, pressurized fluid isolation valve utilizing a gravity biased piston to pierce and clear a flow interruption diaphragm.

A squib valve as described herein refers to a fluid isolation valve that uses a small explosive device to actuate an internal piston that opens the valve. Conventional explosively actuated valves employ an in-line piston to pierce a flow interruption diaphragm. In order to rupture the diaphragm and allow fluid flow through the valve, such an in-line piston is designed to move axially within a portion of the fluid flow path. However, a problem with such a piston configuration is that it must be disposed within a portion of the fluid flow passage. After the piston has served its purpose of rupturing the diaphragm, the entire piston remains within the fluid passage. Accordingly, the piston remains as a significant obstruction to the fluid flow through the valve.

Additionally, in order to accommodate an in-line piston and explosive actuation elements, contemporary valves include a bend in the fluid flow path. In this way, the inlet and outlet ports of the valve are not connected by a straight fluid flow path. The fluid passage bend or elbow provides an access point for installing and servicing the piston and other elements. Unfortunately, such a bend can undesirably restrict or impede fluid flow.

Further, once the diaphragm is ruptured, it remains within the fluid flow path. As such, loose fragments of the ruptured diaphragm can potentially further obstruct or even once again completely block fluid flow through the valve. Consequently, loose fragments of the ruptured diaphragm remaining within the fluid flow passage can lead to an undesirable and potentially dangerous circumstance, making such valves unreliable.

Thus, it is desirable to provide an explosively actuated valve assembly which overcomes the shortcomings found in the art of valves as set forth above while also providing a relatively simple, low-cost design that is reliable and adaptable to suit many environments and applications.

### SUMMARY OF THE INVENTION

The present invention includes a valve assembly having a fluid flow passage, a piston passage, a closure element and a moveable piston. The fluid flow passage extends from an inlet port to an outlet port. The piston passage transects and is oriented non-parallel to the fluid flow passage. The closure element interrupts fluid communication between the inlet and outlet ports. The piston being moveable within the piston passage between a first and second position, the piston including a head for opening the closure element wherein movement of the piston between the first and second positions enables fluid communication between the inlet and outlet ports.

Additionally, the piston movement can remove at least a portion of the closure element from the fluid flow passage. Also, the valve assembly can further include an explosive actuation mechanism for rapid actuation of the piston from the first position to the second position. The explosive actuation mechanism can be a squib. Also, the closure element can be a frangible diaphragm. Further, the piston passage can extend away from two opposed sides of the fluid flow passage. The head can include a retaining element for holding the removed portion of the closure element. The retaining element can include a spike for penetrating the closure element. Also, the head can include a shearing element for separating the portion of the closure element for removal.

Another aspect of the present invention involves a valve assembly including a fluid flow passage, a closure element and a moveable piston. The fluid flow passage extends from an inlet port to an outlet port. The closure element interrupts fluid communication between the inlet and outlet ports. Also; the piston moves between a first and second position. The piston includes a head for opening the closure element, wherein movement of the piston between the first and second positions enables fluid communication between the inlet and outlet ports. Further, the piston movement removes at least a portion of the closure element from the fluid flow passage.

Additionally, the valve assembly can further include a retention chamber for containing at least a portion of the head while in the second position. The retention chamber substantially disposed outside the fluid flow passage. Also, the portion of the closure element can be removed to the retention chamber. Further, the valve assembly can include a piston passage transecting the fluid flow passage, wherein the retention chamber is disposed at one end of the piston passage. The closure element can be a frangible diaphragm. The head can include a retaining element for holding the removed portion of the closure element. The retaining element can include a spike for penetrating the closure element. Also, the head can include a shearing element for separating the portion of the closure element for removal.

These and other embodiments, features, and advantages of this invention will become apparent from the following detailed description of illustrative embodiments thereof, which is to be read in connection with the accompanying drawings.

### BRIEF DESCRIPTION OF THE DRAWINGS

FIG. 1 is a cross-sectional view of a valve assembly in accordance with an embodiment of the present invention.

FIG. 2 is a cross-sectional view of the valve assembly of FIG. 1 in an actuated position.

### DETAILED DESCRIPTION OF THE INVENTION

This invention pertains to an explosively actuated valve assembly that provides a piston assembly that does not significantly obstruct fluid flow through the valve once opened. Also, the valve assembly according to the present invention provides a straight fluid flow passage from the inlet to the outlet port. Further, the valve assembly is designed to remove all loose fragments of the ruptured diaphragm from the fluid flow passage.

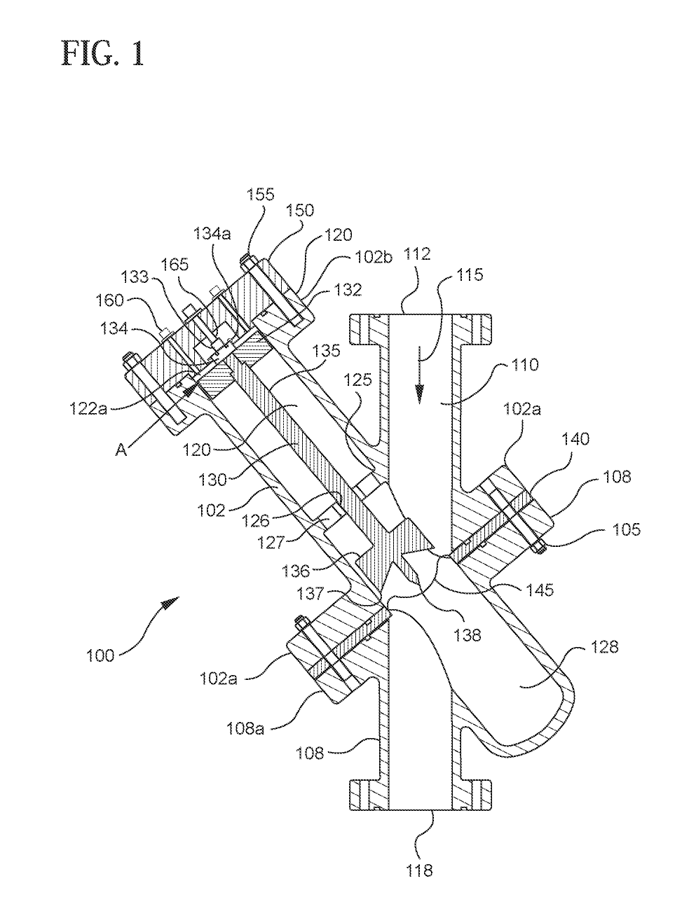

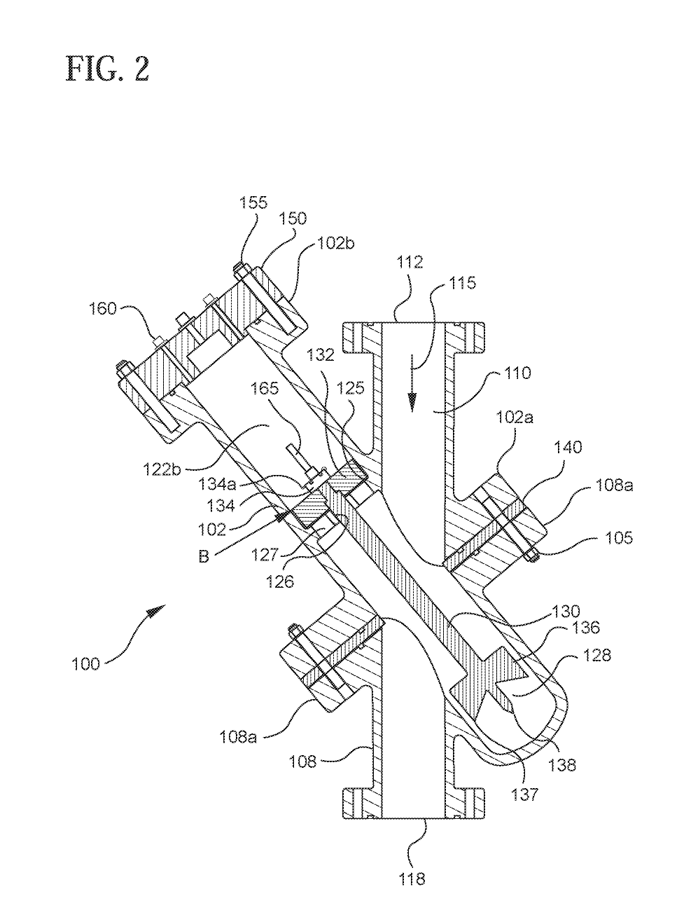

With reference to the drawings, FIG. 1 shows a cross-sectional view of a closed valve assembly in accordance with the present invention. The valve 100 is a squib actuated fluid isolation valve, herein referred to as a squib valve. The squib valve 100, preferably includes a straight through fluid flow passage 110 that in the closed position is interrupted by a diaphragm 140. The diaphragm 140 is designed to remain intact and prevent the possibility of flow through the squib valve 10 until the internal piston 130 is actuated. The piston 130, once actuated by the explosive squib 160, is designed to rupture the diaphragm 140, thereby opening the valve 100. A squib 160 is a pyrotechnic actuator, used to quickly move or propel piston 130. To open the valve 100, a signal is sent to the squib actuation system, thereby firing the squib 160 and driving the piston 130 to pierce and shear the diaphragm 140, thereby allowing fluid communication between the valve inlet 112 and outlet 118. FIG. 2 shows the squib valve 100 in the open position.

FIGS. 1 and 2 also show that the squib valve 100 includes an upper housing 102, a lower housing 108 and a squib housing 150. Preferably, the upper and lower housings 102, 108 are securely coupled and properly aligned to form two intersecting internal passages, namely the fluid passage 110 and the piston passage 120. The upper and lower housings 102, 108 can be made from carbon steel or other durable materials suitable to the application. Similarly, oxidation and corrosion resistant materials, such as stainless steel or inconel can be used. The upper and lower housings 102, 108 are each provided with a coupling flange 102a, 108a, for joining the two housings with the diaphragm 140 there between. As shown, the coupling flanges 102a, 108a are secured with fasteners 105, preferably in the form of a bolt or screw. Alternatively, the outer elements can be joined through mating threads. However, a threaded mating configuration between the upper and lower housings 102, 108 preferably includes added features to ensure proper alignment of the two respective segments of the fluid and piston passages 110, 120. For example markings on the outer housings can serve as alignment features. Also, the apertures for fasteners 105 can be asymmetrically configured to only align when the two housings are properly oriented.

The fluid passage 110 is designed to convey fluid in a straight through flow path 115 from an inlet port 112 to an outlet port 118. Preferably, the inlet port 112 is integrally formed in the upper housing 102 and the outlet port 118 is integrally formed in the lower housing 108. However, alternatively the upper and lower housings 102, 108 can be constructed from multiple housing segments that are secured to form elements similar to those shown. The straight through flow path 115 provides less resistance to flow through the valve 100.

The piston passage 120 intersects and is oriented non-parallel to the fluid passage 110. A piston 130 is moveably disposed along the central longitudinal axis of the piston passage 120. Preferably, the piston passage 120 extends away from the squib housing 150 substantially in a downward direction (toward the ground) upon installation. In this way, gravity will induce the piston 130 to remain in the open position, once the squib 160 is activated. The longitudinal extent of the piston passage 130 need not be perpendicular to the ground. As shown, the piston passage 120 preferably intersects the fluid passage 110 at an acute angle. This configuration provides a means of easily installing a diaphragm 140 within the intersection of both passages 110, 120. It should be understood that the design of the valve 100, particularly the orientation of the passages 110, 120, can be formed differently to suit a particular environment. Accordingly, the valve 100 can be formed so that the angle of intersection between the fluid passage 110 and the piston passage 120 is either smaller or larger than that shown.

An upper portion of the piston passage 120 is formed by the upper housing 102 and contains substantially the entire the piston 130 therein when the valve 100 is closed. A lower portion of the piston passage 120 is formed by the lower housing 108. The lowest portion of the piston passage is referred to as the piston head retention area 128. After the valve 100 is opened by firing the squib 160, at least the piston head 136 is preferably contained within retention area 128, thereby keeping the head 136 out of the fluid passage 110. Also, any sheared central diaphragm 145 material will also be removed from the fluid passage 110 and deposited in the retention area 128.

The piston 130 is designed to move from the position shown in FIG. 1, to the position shown in FIG. 2. The piston 130 preferably includes a piston shoe 132, a piston shaft 135 and a piston head 136. The piston shaft 135 passes through a piston stop 125 protruding from the inner walls of the piston passage 120. Preferably, the piston stop 125 is integrally formed with the upper housing 102 and takes the form of a perforated disk that interrupts piston passage 120. Particularly, the piston stop 125 includes a central aperture 126 which serves to guide the piston shaft 135 that passes there through. Both the central aperture 126 and the piston shoe 132 guide the piston 130 along a central longitudinal axis of the piston passage 120. Once the squib is activated and the piston shoe 132 moves from position A toward position B, it is the piston stop 125 that limits further axial movement of the piston shoe 132, and thereby the piston 130 itself. Additionally, the piston stop 125 is preferably provided with additional apertures 127 to avoid trapping air within the piston passage 120 on the squib-side of the piston stop 125, which might otherwise inhibit movement of the piston 130 toward the a fully open position. Similarly, the piston shoe 132 is preferably provided with such apertures (not shown) to avoid the resistance that might otherwise be created as the piston shoe 132 moves away from the squib housing 150. During actuation, as the piston shoe 132 moves, the volume 122a above the piston shoe 132 expands to a larger volume 122b. It should be understood that the size and/or number of piston stop apertures 125 or piston shoe apertures can be altered or adjusted accordingly to suit the desired valve action.

For ease of assembly, the piston shoe 132 is removeably secured to the piston shaft 135 by piston nut 134. Thus, during assembly the piston shaft 135 can be inserted through the piston stop central aperture 126 and the piston shoe 132 then added. As shown, the piston shoe 132 is seated on an upper portion of the piston shaft and secured thereto by a piston nut 134 which is threaded onto the upper end 133, thereby securing the shoe 132 to the shaft 135. Alternatively, the piston shoe 132 and piston shaft 135 can be integrally formed. However, for assembly purposed, the piston head 136 would then need to be removable from the shaft 135, such as through a threaded coupling.

The piston head 136 includes a spike 138 and shearing blades 137. The spike 138 is designed to pierce the diaphragm central portion 145, and the shearing blades 137 are designed to shear away a substantial amount of the central portion 145. Preferably, the shearing blades 137 are the sharpened leading edges of the outer perimeter of the cylindrical piston head 136. The spike 138 axially protrudes beyond the shearing blades 137, such that as the piston head 136 moves toward the diaphragm 140, the spike 138 preferably engages and penetrates the center of diaphragm 140 before the shearing blades 137 engages the outer edges of the central portion 145. In this way, after the spike 138 pierces the diaphragm, the shearing blades 137 tear through the outer edges of the central portion 145. Thus, substantially all material forming the central portion 145 is held on the spike 138, as it is removed from the passages 110, 120 and conveyed to retention area 128. Preferably, the leading face of the piston head 136 has a concave design for collecting and conveying any separated pieces of central portion 145 after they are sheared from the diaphragm. Thus, the piston head 136 maintains any separated pieces of central portion 145 from obstructing fluid flow through the fluid passage 110. FIGS. 1 and 2 show a concave conical design for the lead/bottom face of the piston head 136, however the concave depression can be formed as a cup or more non-symmetrical shape.

Preferably, the piston head 136 is made of a durable materials, such as those described above for the housings 102, 108. However, the design is not limited to any specific materials, but rather certain materials properties are preferred based on application parameters, such as the material composition of the diaphragm 140, what types of fluids, and the pressures and temperatures involved. Also, alternatively the piston passage 120 can be formed with a continuous or parabolic curvature. The piston 130 and particularly the piston stem 135 could be similarly curved to conform to such a curved piston passage 120.

The upper and lower housings 102, 108 are each provided with flanges 102a, 108a for securely coupling the two housings with the diaphragm 140 between. The two housings 102, 108 are preferably aligned to form straight and continuous inner passages 110, 120 that are both interrupted by the diaphragm 140. The diaphragm 140 is formed as a disc and is secured between the upper and lower housings 102, 108. The outer portions of the diaphragm 140 acts as a sealing ring and includes apertures for receiving retainers 105. Also, additional sealing or bonding agents or materials can be provided between flanges 102a, 108a for ensuring a proper seal between the two housing members 102, 108. Additionally, a frangible diaphragm central portion 145 is provided. The central portion 145 can be integrally formed with the outer portions of the diaphragm 140 or formed from separate pieces. The central portion 145 should be strong enough to remain intact before actuation of the piston, thus preventing fluid flow through the valve 100. Also, the central portion 145 is designed to rupture and shear away once acted upon by the piston head 136. The diaphragm is preferably formed from inorganic metallic elements, such as stainless steel or a stainless superalloy.

The squib housing 150 is secured to an upper end of the upper housing 102. Preferably, the upper housing 102 is provided with another coupling flange 102b upon which the squib housing 150 is secured with a fastener 155. The union of these two housings 102, 150 should maintain a good seal before, during and after the squib is activated. The squib housing 150 holds one or more squibs 160, which is coupled to a squib activation system (not shown). The squib burn rate, pressure and volume can be selected and/or adjusted to provide the required valve action.

Also, secured to the squib housing 150 is a frangible link 165 that holds the piston 130 in the position shown in FIG. 1. The frangible link 165 can be in the form of a frangible threaded bolt that passes through an aperture in the squib housing 150 and is threadedly secured to the top end of the piston shaft 135. When commanded by a user or programmable interface, the squib actuation system sends a signal to fire to the squibs 160. Thereafter, firing the squib 160 thus pressurizing volume 122a that causes a differential pressure across the piston shoe 132 and develops force sufficient to propel the piston 130 and brake the frangible link 165 holding the piston 130 in place. Also, the force drives the piston head 136 to rupture and shear the diaphragm central portion 145, and deposit the sheared portion(s) in retention area 128. Once the diaphragm 140 is breached, the fluid flow path 115 is opened allowing fluid to flow through the squib valve. Once the frangible link 165 is broken, the weight of the piston 130 will help maintain the piston head 136 in the retention area 128.

Generally, the squibs 160 are an explosive actuation mechanism that quickly releases a pressure wave. The squibs 160 can by any suitable electrically operable pressure source. Preferably, a squib 160 is a pyrotechnic device that may be mounted in the housing 150, and which, when activated, provides a pressure wave that forces piston 130 rapidly towards retention area 128 of lower housing 108. Alternatively, the squibs 160 could be a non-pyrotechnic device capable of quickly releasing sufficient pressure to properly actuate the piston 130. The pressure wave provided by the one or more squibs 160 may be of any predetermined magnitude according to the requirements of a specific device and the application thereof. An example of an electrically operable pressure source is described in U.S. Pat. No. 5,443,088 to Hoch et al. and incorporated herein by reference.

It should be understood that some or all of the outer housings 102, 108, 150 can be formed by more parts than that shown. Also, additional or redundant sealing elements can be employed, such as metal or rubber o-rings, spring wound rings, v-rings, welding or other known sealing elements and/or techniques.

While various embodiments of the present invention are specifically illustrated and/or described herein, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A valve assembly comprising:
a fluid flow passage extending from an inlet port to an outlet port;
a piston passage transecting and oriented non-parallel to said fluid flow passage;
a closure element interrupting fluid communication between said inlet and outlet ports; and
a piston moveable within said piston passage between a first and second position, said piston including a head for opening said closure element wherein movement of said piston between said first and second positions enables fluid communication between said inlet and outlet ports.

2. The valve assembly of claim 1, wherein said piston movement removes at least a portion of said closure element from said fluid flow passage.

3. The valve assembly of claim 1, further comprising:
an explosive actuation mechanism for rapid actuation of said piston from said first position to said second position.

4. The valve assembly of claim 3, wherein said explosive actuation mechanism is a squib.

5. The valve assembly of claim 1, wherein said closure element is a frangible diaphragm.

6. The valve assembly of claim 1, wherein said piston passage extends away from two opposed sides of said fluid flow passage.

7. The valve assembly of claim 2, wherein said head includes a retaining element for holding said portion of said closure element.

8. The valve assembly of claim 2, wherein said head includes a shearing element for separating said portion of said closure element.

9. The valve assembly of claim 8, wherein said head further includes a retaining element for holding said portion of said closure element.

10. The valve assembly of claim 9, wherein said retaining element includes a spike for penetrating said closure element.

11. A valve assembly comprising:
a fluid flow passage extending from an inlet port to an outlet port;
a closure element interrupting fluid communication between said inlet and outlet ports; and
a piston moveable between a first and second position, said piston including a head for opening said closure element wherein movement of said piston between said first and second positions enables fluid communication between said inlet and outlet ports, wherein said piston movement removes at least a portion of said closure element from said fluid flow passage.

12. The valve assembly of claim 11, further comprising:
a retention chamber for containing at least a portion of said head while in said second position, said retention chamber substantially disposed outside said fluid flow passage.

13. The valve assembly of claim 12, wherein said portion of said closure element is removed to said retention chamber.

14. The valve assembly of claim 12, further comprising:
a piston passage transecting said fluid flow passage, wherein said retention chamber is disposed at one end of said piston passage.

15. The valve assembly of claim 11, further comprising:
an explosive actuation mechanism for rapid actuation of said piston from said first position to said second position.

16. The assembly of claim 11, wherein said closure element is a frangible diaphragm.

17. The assembly of claim 11, wherein said head includes a retaining element for holding said portion of said closure element.

18. The assembly of claim 11, wherein said head includes a shearing element for separating said portion of said closure element.

19. The assembly of claim 18, wherein said head further includes a retaining element for holding said portion of said closure element after it is separated.

20. The assembly of claim 19, wherein said retaining element includes a spike for penetrating said closure element.
